(19) United States
(12) Patent Application Publication
(10) Pub. No.: US 2011/0106815 A1
(43) Pub. Date: May 5, 2011

(54) Method and Apparatus for Selectively Re-Indexing a File System

(75) Inventors: Justin Tyler Dubs, Durham, NC (US); Julie Anne Morris, Raleigh, NC (US); Joshua Neil Novak, Wake Forest, NC (US); Michael Terrell Vanover, Raleigh, NC (US)

(73) Assignee: LENOVO (SINGAPORE) PTE, LTD., New Tech Park (SG)

(21) Appl. No.: 12/610,939

(22) Filed: Nov. 2, 2009

(51) Int. Cl. G06F 17/30

(52) U.S. Cl. 707/747; 707/E17.002; 707/E17.01; 707/741; 707/705

(57) ABSTRACT

A method and apparatus are disclosed for re-indexing a file system is disclosed. A detection module detects a reconnection of a storage device to an electronic device. The storage device was previously connected to and then disconnected from the electronic device. The storage device comprises a file system and the electronic device stores first metadata indexing the file system. A determination module determines if the file system is changed since the previous connection. An access module accesses the file system using the first metadata in response to the file system not changing since the previous connection. A re-index module re-indexes the file system in response to the file system changing since the previous connection.

### BACKGROUND

1. Field

The subject matter disclosed herein relates to files systems and more particularly relates to selectively re-indexing a file system.

2. Description of the Related Art

Highly portable storage devices allow a user to carry significant amounts of data easily. In addition, network connections also allow the user to store and access data remotely. This allows the user's data to be accessible wherever the user is, with the data usable on multiple electronic devices.

The data on the storage device is typically organized in a file system. The file system may be indexed before it can be efficiently searched by an electronic device. Indexing the data can require a significant amount of time, particularly if the storage device stores a large amount of data. Unfortunately, the storage device must be re-indexed each time it is connected to an electronic device, reducing the convenience of storing large amounts of data on a storage device.

### SUMMARY

From the foregoing discussion, there is a need for a method and apparatus that selectively re-indexes a file system. Beneficially, such a method and apparatus would speed access to data on a storage device that is reconnected to an electronic device.

The embodiments of the present invention have been developed in response to the present state of the art, and in particular, in response to the problems and needs in the art that have not yet been fully solved by currently available file system re-indexing methods. Accordingly, the embodiments have been developed to provide a method and apparatus for selective file system re-indexing that overcome many or all of the above-discussed shortcomings in the art.

A method is presented for selective file system re-indexing. In one embodiment, the method includes detecting a reconnection of the storage device to electronic device, determining if a file system is changed, accessing the file system using first metadata, and re-indexing the file system.

A detection module detects a reconnection of a storage device to an electronic device. The storage device was previously connected to and then disconnected from the electronic device. The storage device comprises a file system and the electronic device stores first metadata indexing the file system.

A determination module determines if the file system is changed since the previous connection. An access module accesses the file system using the first metadata in response to the file system not changing since the previous connection. A re-index module re-indexes the file system in response to the file system changing since the previous connection.

The apparatus for selective file system re-indexing is provided with a plurality of modules configured to functionally execute the steps of the method. The modules include a detection module, a determination module, an access module, and a re-index module.

The detection module detects a reconnection of a storage device to an electronic device. The storage device was previously connected to and then disconnected from the electronic device. The storage device comprises a file system and the electronic device stores first metadata indexing the file system.

The determination module determines if the file system is changed since the previous connection. The access module accesses the file system using the first metadata in response to the file system not changing since the previous connection. The re-index module re-indexes the file system in response to the file system changing since the previous connection.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

Embodiments of the present invention may selectively re-index a file system, so that the file system is only re-indexed when necessary, speeding access to data in the file system when re-indexing is not required. These features and advantages of the embodiments will become more fully apparent from the following description and appended claims, or may be learned by the practice of the embodiments as set forth hereinafter.

### BRIEF DESCRIPTION OF THE DRAWINGS

In order that the advantages of the embodiments will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a storage device and electronic device system;

FIG. 2 is a drawing illustrating one embodiment of a server and computer system;

FIG. 3 is a drawing illustrating one embodiment of a portable device and computer system;

FIG. 4 is a drawing illustrating one embodiment of a storage device and computer system;

FIG. 5 is a schematic block diagram illustrating one embodiment of an electronic device;

FIG. 6 is a schematic block diagram illustrating one embodiment of a re-indexing apparatus; and

FIG. 7 is a schematic flow chart diagram illustrating one embodiment of a selective re-indexing method.

### DETAILED DESCRIPTION

Many of the functional units described in this specification have been labeled as modules, in order to more particularly emphasize their implementation independence. Modules may include hardware circuits such as one or more processors with memory, Very Large Scale Integration (VLSI) circuits, gate arrays, programmable logic, and/or discrete components. The hardware circuits may perform logic functions, execute computer readable and processor readable programs stored on tangible storage devices, and/or execute programmed functions. Modules may also include a processor readable storage medium comprising a processor readable program stored on a tangible memory device that performs a function when executed by a hardware circuits such as a processor, microcontroller, or the like.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

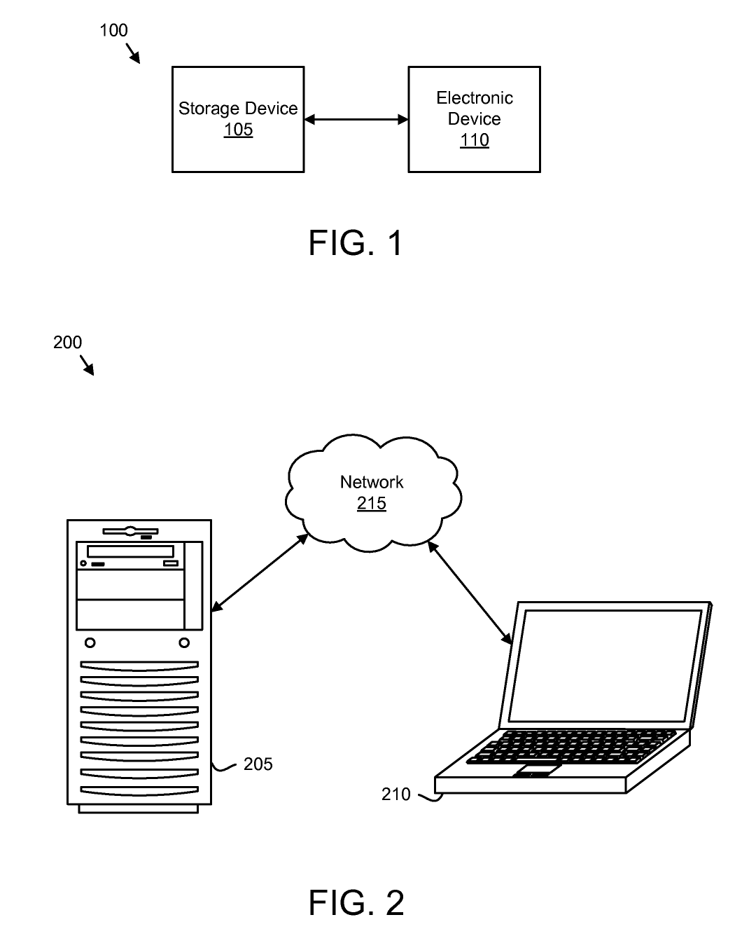

FIG. 1 is a schematic block diagram illustrating one embodiment of a storage device and electronic device system 100. The system 100 includes a storage device 105 and electronic device 110. The storage device 105 may be a Flash drive, a Smart card, or the like. The electronic device 110 may be a computer, a thin client computer, a mobile telephone, a portable digital assistant, or the like.

In one embodiment, the storage device 105 may store personal data for a user. The personal data may include image files, audio files, music files, and document files. In addition, the storage device 105 may store business data for the user. The business data may include a download of a portion of enterprise data, data received from sources outside the user's own organization, and the like.

The data may be organized in a file system. In one embodiment, the file system is a File Allocation Table 32 (FAT32) file system. Alternatively, the file system may be a File Allocation Table (FAT) file system. In addition, the file system may be a New Technology File System (NTFS), High Performance Files System (HPFS), an Extended File Allocation Table (exFAT) file system, a Linux file system, and the like. The file system may be configured as a Master Boot Record (MBR) partition file system.

The storage device 105 is shown connecting to the electronic device 110. The electronic device 110 may access the file system of the storage device 105 while the storage device 105 is connected to the electronic device 110. The electronic device 110 may create metadata that indexes the file system. In addition, the electronic device 110 may use the metadata to access the files and data of the file system.

A user may disconnect the storage device 105 from the electronic device 110. The user may subsequently connect the storage device 105 to an alternate electronic device and modify the data of the file system using the alternate electronic device. The user may then reconnect the storage device 105 to the electronic device 110 after the data of the file system is modified. Alternatively, the user may reconnect the storage device 105 to the electronic device 110 without having modified the data of the file system.

In the past, each time the user reconnects to the storage device 105 to the electronic device 110, the electronic device 110 is required to re-index the file system before the electronic device 110 could access data in the file system. Embodiments of the present invention selectively re-index the file system, allowing the electronic device 110 to immediately access the data of the file system without re-indexing the file system if the file system has not changed since the storage device 105 was last connected to the electronic device 110. Thus the embodiments can speed the electronic device 110 in accessing the data of the storage device 105.

FIG. 2 is a drawing illustrating one embodiment of a server and computer system 200. A server 205 may be the storage device 105 of FIG. 1. In addition, a portable computer 210 may be the electronic device 110 of FIG. 1. The server 205 stores data for the portable computer 210. In addition, the server 205 connects to the portable computer 210 through a network 215.

In one embodiment, the portable computer 210 periodically connects to the server 205 through the network 215. The server 205 may access one or more server storage devices such as hard disk drives, micromechanical storage devices, and the like. The server 205 includes a file system that stores data for the portable computer 210. In one embodiment, the file system of the server 205 is a portion of a server file system. The portable computer 210 may access the file system when the portable computer 210 is connected to the server 205.

For example, the server 205 may store an extensive file system of video data. The portable computer 210 is connected to the server 205 in order to access the file system of video data. The portable computer 210 may subsequently disconnect from the server 205. When the portable computer 210 reconnects to the server 205, the portable computer 210 selectively re-indexes the file system if there has been a change to the file system. Alternatively, the portable computer 210 may immediately access the video data of the file system if the file system has not changed since the previous connection of the portable computer 210 to the server 205.

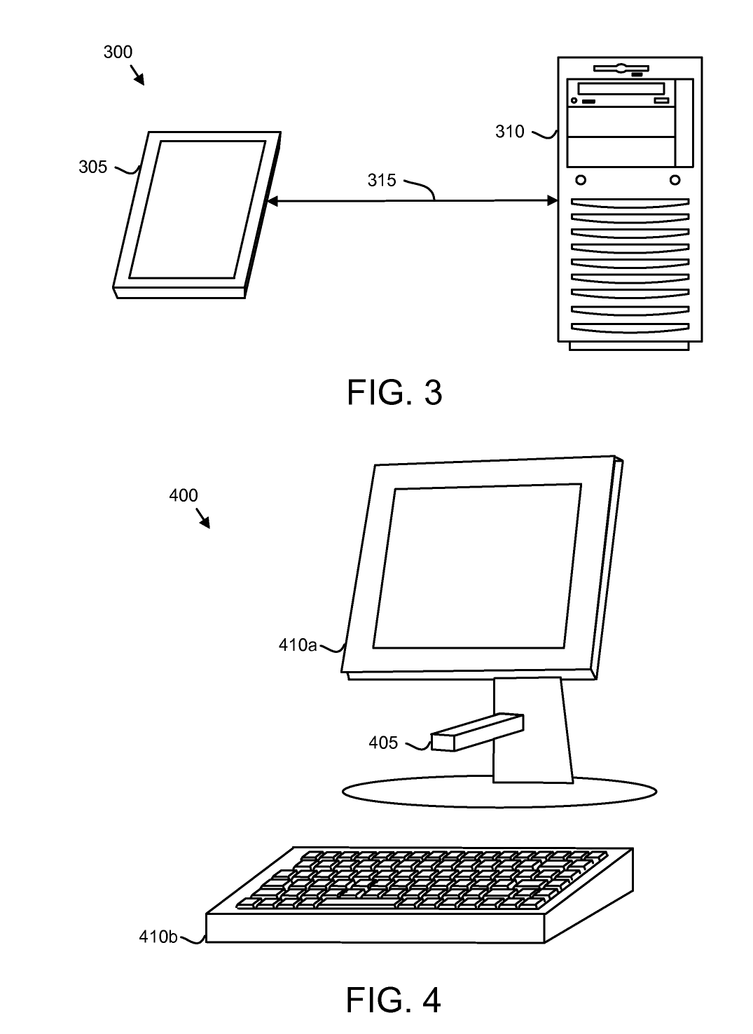

FIG. 3 is a drawing illustrating one embodiment of a portable device and computer system 300. A portable device 305 connects to a computer 310 through a connection 315. The portable device 305 may be an embodiment of the storage device 105 of FIG. 1. In addition, the computer 310 may be an embodiment of the electronic device 110 of FIG. 1. In an alternate embodiment, the portable device 305 is the electronic device 110 and the computer 310 is the storage device 105 of FIG. 1.

The connection 315 may be a wireless connection. For example, the connection 315 may be Bluetooth connection, a Wi-Fi connection, a cellular telephone network connection, and the like. Alternatively, the connection 315 may be a network connection such as an Ethernet connection, a token ring connection, and the like.

In one embodiment, the connection 315 is a Universal Serial Bus (USB) connection. Alternatively, the connection 315 may be a FireWire connection, a telephone connection, a parallel bus connection, or the like.

The portable device 305 may be a cellular telephone, a personal digital assistant (PDA), an ultra-mobile computer, and the like. The computer 310 may be a computer workstation, a server, and the like.

In one embodiment, the portable device 305 includes a file system. The file system stores data for user. The user may carry the portable device 305, so that the portable device 305 is readily accessible. When the user employs the computer 310, the user may connect the portable device 305 to the computer 310 using the connection 315. The computer 310 may access the file system of the portable device 305, allowing the user to access and manipulate data of the file system on the portable device 305 using the computer 310.

For example, the portable device 305 may be a cellular telephone. The user may store data such as images files, audio files, video files, and document files on the cellular telephone. The user may connect the portable device 305 to the computer 310 in order to access documents on the cellular telephone portable device 305 using the computer 310.

FIG. 4 is a drawing illustrating one embodiment of a storage device and computer system 400. A portable storage device 405 may be the storage device 105 FIG. 1. In addition, a thin client computer 410 may be the electronic device 110 FIG. 1.

The thin client computer 410 includes a monitor 410a and a keyboard 410b. The thin client computer 410 may store programs on a hard disk drive. Alternatively, the thin client computer 410 may download programs as needed over a network. In one embodiment, the thin client computer 410 does not store user data. The user data may be stored on the portable storage device 405. The portable storage device 405 may be Flash drive, a Smart card, a Secure Digital (SD) card, and the like.

The user may employ the thin client computer 410 to access and manipulate data stored on the portable storage device 405. In addition, the thin client computer 410 may store data to and retrieve data from the portable storage device 405.

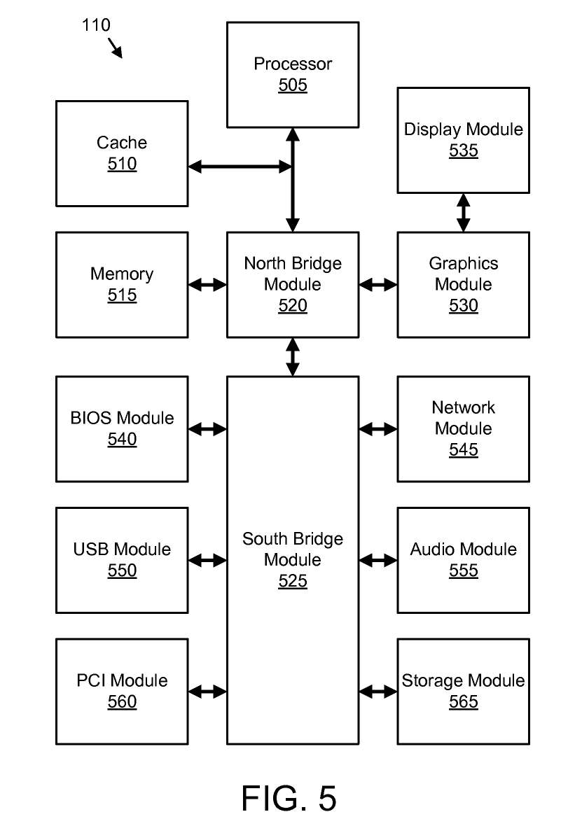

FIG. 5 is a schematic block diagram illustrating one embodiment of an electronic device 110 that may be the electronic device 110 of FIG. 1. In the depicted embodiment, electronic device 110 is a computer. The electronic device 110 includes a processor 505, a cache 510, a memory 515, a north bridge module 520, a south bridge module 525, a graphics module 530, a display module 535, a basic input/output system (BIOS) module 540, a network module 545, a USB module 550, an audio module 555, a peripheral component interconnect (PCI) module 560, and a storage module 565.

The processor 505, cache 510, memory 515, north bridge module 520, south bridge module 525, graphics module 530, display module 535, BIOS module 540, network module 545, USB module 550, audio module 555, PCI module 560, and storage module 565, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices.

The processor 505 executes the processor readable programs as is well known to those skilled in the art. The processor readable programs may be tangibly stored in the memory 515. The processor readable programs may also be tangibly stored in the storage module 565. The storage module 565 may be a hard disk drive, an optical storage device, a holographic storage device, a micromechanical storage device, a semiconductor storage device, or the like.

The processor 505 may communicate with the cache 510 through a processor interface bus to reduce the average time to access the memory 515. The cache 510 may store copies of the data from the most frequently used memory 515 locations.

The north bridge module 520 may communicate with and provide bridging functionality between the processor 505, the graphic module 530, the memory 515, and the cache 510. The processor 505 may be connected to the north bridge module 520 over a, for example, six hundred sixty seven Megahertz (667 MHz) front side bus.

The north bridge module 520 may be connected to the south bridge module 525 through a direct media interface (DMI) bus. The DMI bus may provide a high-speed, bi-directional, point-to-point link supporting a clock rate for example of one Gigabytes per second (GBps) in each direction between the north bridge module 520 and the south bridge module 525. The south bridge module 525 may support and communicate with the BIOS module 540, the network module 545, the PCI module 560, and the storage module 565.

The PCI module 560 may communicate with the south bridge module 525 for transferring data or power to peripheral devices. The PCI module 560 may include a PCI bus for attaching the peripheral devices. The PCI bus can logically connect several peripheral devices over the same set of connections. The peripherals may be selected from a printer, a joystick, a scanner, or the like. The PCI module 560 may also comprise an expansion card as is well known to those skilled in the art.

The BIOS module 540 may communicate instructions through the south bridge module 525 to boot the electronic device 110, so that processor readable programs stored on the storage module 565 can load, execute, and assume control of the electronic device 110. Alternatively, the BIOS module 540 may comprise a coded program embedded on a chipset that recognizes and controls various devices that make up the electronic device 110.

The network module 545 may communicate with the south bridge module 525 to allow the electronic device 110 to communicate with other devices over a network such as the network 215 of FIG. 1. The devices may include routers, bridges, computers, printers, and the like.

The display module 535 may communicate with the graphic module 530 to display information as will be described hereafter. The display module 535 may be a cathode ray tube (CRT), a liquid crystal display (LCD) monitor, electronic ink, or the like. The USB module 550 may communicate with one or more USB compatible devices such as the portable storage device 405 over a USB bus. The audio module 555 may generate an audio output.

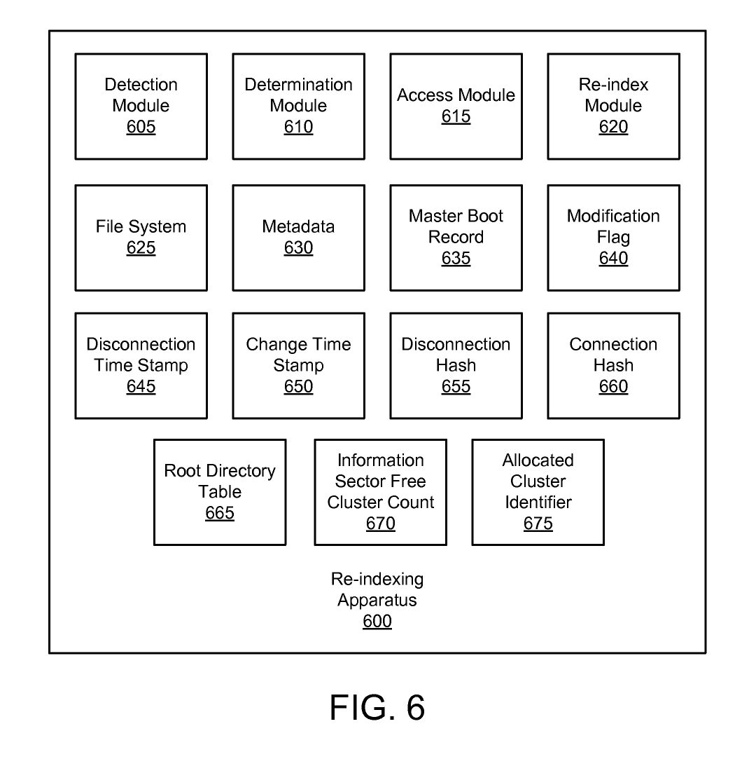

FIG. 6 is a schematic block diagram illustrating one embodiment of a re-indexing apparatus 600. The re-indexing apparatus 600 may be embodied in the storage device 105 and the electronic device 110 of FIG. 1. The description of the re-indexing apparatus 600 refers to elements of FIGS. 1-5, like numbers referring to like elements. The re-indexing apparatus 600 includes a detection module 605, a determination module 610, an access module 615, a re-index module 620, a file system 625, metadata 630, a master boot record 635, a modification flag 640, a disconnection time stamp 645, a change time stamp 650, a disconnection hash 655, a connection hash 660, a root directory table 665, an information sector free cluster count 670, and an allocated cluster identifier 675.

In one embodiment, the detection module 605, the determination module 610, the access module 615, and the re-index module 620 may be embodied in a processor readable storage medium comprising a processor readable program stored on a tangible memory device such as the memory 515 or the storage module 565. The processor readable program may be executed by the processor 505 to perform the functions of the detection module 605, determination module 610, the access module 615, and the re-index module 620. The file system 625, metadata 630, master boot record 635, modification flag 640, disconnection time stamp 645, change time stamp 650, disconnection hash 655, connection hash 660, root directory table 665, and information sector free cluster count 670, and an allocated cluster identifier 675 may be embodied in data tangibly stored on a memory device such as the memory 515 and/or the storage module 565, or on the storage device 105.

The detection module 605 detects a reconnection of the storage device 105 to the electronic device 110. The storage device 105 was previously connected to and then disconnected from the electronic device 110. The storage device 105 may comprise the file system 625. The electronic device 110 may store the metadata 630 indexing the file system 625.

The metadata 630 may be a table of contents, a database, an index, or the like. The metadata 630 may include an entry for each object stored in the file system 625. File system objects may include files, directories, folders, pointers, and the like.

The master boot record 635 may be a first sector of a partitioned storage module 565. For example, the storage module 565 may be a hard disk drive. The first sector of the hard disk drive may have a Logical Block Address (LBA) of 0. The master boot record 635 may store a partitioning table. In addition, the master boot record 635 may store instructions to boot the electronic device 110. In an alternate embodiment, the master boot record 635 may be a volume boot record for a non-partitioned storage module 565.

The modification flag 640 may be a data register and/or data field that is set to a specified value when the file system 625 is modified while connected to the electronic device 110. In one embodiment, the modification flag 640 is set to a true value when the file system 625 is modified and is set to a false value when the file system 625 is re-indexed. In a certain embodiment, the modification flag 640 includes a plurality of entries. Each entry may include the data field storing the specified value and an electronic device identifier. A first electronic device 110 may set all specified values to true for all entries when the electronic device 110 modifies the file system 625 and set the specified value to false for the first electronic device entry when the first electronic device 110 re-indexes the file system 625.

The root directory table 665 may store information about the objects of the root directory of the file system 625. The root directory table 665 may record a last access time for the file system 625. In addition, the root directory table 665 may record a last modified time.

The storage device 105 may be organized as a plurality of clusters. The information sector free cluster count 670 may store a count of free or unused clusters on the storage device 105. The information sector free cluster count 670 may be incremented each time a cluster is the deallocated and decremented each time a cluster is allocated on the storage device 105.

The allocated cluster identifier 675 may store a list of allocated clusters on the storage device 105. The allocated cluster identifier 675 may be updated each time a cluster is allocated or deallocated on the storage device 105.

The disconnection time stamp 645 may record a time that the storage device 105 is disconnected from the electronic device 110. As used herein, time refers to a date and the time. The disconnection time stamp 645 may be recorded on the electronic device 110. Alternatively, the disconnection time stamp 645 may be recorded on the storage device 110.

The change time stamp 650 may record a time of a last change to the file system 625. The change time stamp 650 may be stored on the storage device 110.

In one embodiment, the detection module 605 calculates the change time stamp 650 and the disconnection time stamp 645 from the last access time of the root directory table 665. Alternatively, the detection module may calculate the change time stamp 650 and the disconnection time stamp 645 from the last modified time of the root directory table 665.

The detection module 605 may calculate the disconnection hash 655 for the storage device 105 in response to the storage device 105 being disconnected from the electronic device 110. The detection module 605 may also calculate the connection hash 660 in response to the storage device 105 being connected to the electronic device 110. In one embodiment, the detection module 605 calculates the connection hash 660 and the disconnection hash 655 from the information sector free cluster count 670 as a hash of the information sector free cluster count 670. In an alternate embodiment, the detection module 605 calculates the connection hash 660 and the disconnection hash 655 from the allocated cluster identifier 675 as a hash of the allocated cluster identifier 675.

The determination module 610 determines if the file system 625 is changed from the previous connection as will be described hereafter. The access module 615 accesses the file system 625 using the metadata 630 in response to the file system 625 not changing since the previous connection. If the file system 625 is changed since the previous connection, the re-index module 620 re-indexes the file system 625. In one embodiment, the re-index module 620 re-indexes the file system 625 by creating new metadata 630 indexing the file system 625. The access module 615 may access the file system 625 using the new metadata 630.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

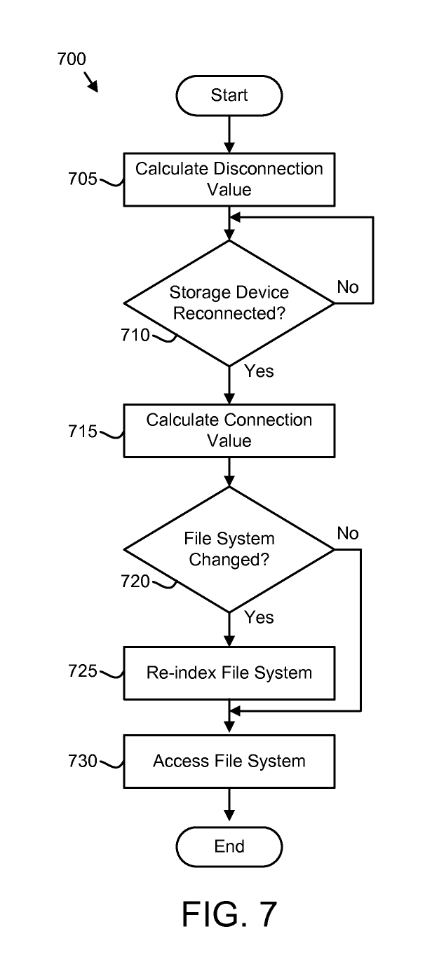

FIG. 7 is a schematic flow chart diagram illustrating one embodiment of a selective re-indexing method 700. The method 700 substantially includes the steps to carry out the functions presented above with respect to the operation of the described apparatus and system of FIGS. 1-6. The description of the method 700 refers to elements of FIGS. 1-6, like numbers referring to like elements.

In one embodiment, the method 700 is implemented with a processor readable storage medium comprising a processor readable program stored on a tangible memory device. The processor readable storage medium may be integrated into the electronic device 110, wherein the processor readable program executed by the processor 505 performs the method 700.

The method 700 starts, and one embodiment, the detection module 605 calculates 705 a disconnection value. The detection module 605 may calculate 705 the disconnection value in response to the storage device 105 being disconnected from the electronic device 110. The disconnection value may be the disconnection time stamp 645. In one embodiment, the detection module 605 calculates 705 the disconnection time stamp 645 from the last access time of the root directory table 665. In an alternate embodiment, the detection module 605 calculates 705 the disconnection time stamp 645 from the last modified time of the root directory table 665. The detection module 605 may also calculates 705 the disconnection time stamp 645 from a time stamp of the master boot record 635.

Alternatively, the disconnection value may be the disconnection hash 655. The detection module 605 may calculate 705 the disconnection hash 655 as a hash of the information sector free cluster count 670. Alternatively, the detection module 605 may calculate 705 the disconnection hash 655 as a hash of the allocated cluster identifier 675. In a certain embodiment, the detection module 605 calculates 705 the disconnection hash 655 as a hash of the master boot record 635.

The detection module 605 further detects 710 a reconnection of the storage device 105 to electronic device 110. The storage device 105 is previously connected to and disconnected from the electronic device 110. The storage device 105 comprises a file system 625. The electronic device 110 stores first metadata 630 indexing the file system 625. If the detection module 605 does not detect 710 the reconnection of the storage device 105, the detection module 605 continues to attempt to detect 710 the reconnection of the storage device 105.

If the detection module 605 detects 710 the reconnection of the storage device 105 to the electronic device 110, the detection module 605 calculates 715 a connection value. The connection value may be the change time stamp 650. In one embodiment, the detection module 605 calculates 715 the change time stamp 650 from the last access time of the root directory table 665. In an alternate embodiment, the detection module 605 calculates 715 the change time stamp 650 from the last modified time of the root directory table 665. The detection module 605 may also calculate 715 the change time stamp 650 from a time stamp of the master boot record 635.

Alternatively, the connection value may be the connection hash 660. The detection module 605 may calculate 715 the connection hash 660 as a hash of the information sector free cluster count 670. Alternatively, the detection module 605 may calculate 715 the connection hash 660 as a hash of the allocated cluster identifier 675. In one embodiment, the detection module 605 calculates 715 the connection hash 660 as a hash of the master boot record 635.

The determination module 610 determines 720 if the file system 625 is changed since the previous connection. In one embodiment, the determination module 610 determines 720 the file system 625 is changed since the previous connection if the change time stamp 650 is later than the disconnection time stamp 645. Alternatively, a determination module 610 determines 720 that the file system 625 is changed since the previous connection if the connection hash 655 is not equivalent to the connection hash 660.

In one embodiment, a determination module 610 determines 720 at the file system 625 is changed if the master boot record 635 is modified. In a certain embodiment, the master boot record 635 is modified if the change time stamp 650 calculated 715 from the time stamp of the master boot record 635 is later than the disconnection time stamp 645 calculated 705 from the time stamp of the master boot record 635.

The determination module 610 may determine 720 that the file system 625 is changed if the modification flag 640 is set. In one embodiment, the modifications flag 640 is set each time the file system 625 is modified and reset each time the file system 625 is re-indexed by the electronic device 110.

If the determination module 610 determines 720 that the file system is changed, the re-index module 620 re-indexes 725 is the file system 625 in response to the file system 625 changing since the previous connection. In one embodiment, the re-index module 620 re-indexes 725 the file system 625 by creating second metadata 630 that indexes the file system 625. The access module 615 may then access 730 the file system 625 of the storage device 105 using the second metadata 630, and the method 700 ends.

If the determination module 610 determines 720 that the file system is not changed, the access module 615 may access 730 the file system 625 storage device 105 using the first metadata 630 in response to the file system 625 not changing since the previous connection, and the method 700 ends.

The method 700 only re-indexes 725 the file system 625 if the file system 625 is changed since the previous connection of the storage device 105 to the electronic device 110. If the file system 625 is not changed since the previous connection, the access module 615 of the electronic device 110 may immediately access 730 the file system 625 without a delay for re-indexing 725 the file system 625. Thus a user may more conveniently and rapidly access data stored on the storage device 105 if the file system 625 has not been changed.

Embodiments of the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A processor readable storage medium comprising a processor readable program stored on a tangible memory device, wherein the processor readable program when executed on a processor causes an electronic device to:
detect a reconnection of a storage device to the electronic device wherein the storage device was previously connected to and then disconnected from the electronic device, the storage device comprising a file system and the electronic device storing first metadata indexing the file system;
determine if the file system is changed since the previous connection;
access the file system using the first metadata in response to the file system not changing since the previous connection; and
re-index the file system in response to the file system changing since the previous connection.

2. The processor readable storage medium of claim 1, wherein the processor readable program further causes the electronic device to determine that the file system is changed from criteria selected from the group consisting of a master boot record modification and a set file system modification flag.

3. The processor readable storage medium of claim 1, wherein the processor readable program further causes the electronic device to calculate a disconnection time stamp for the storage device in response to the storage device being disconnected from the electronic device, calculate a change time stamp in response to the storage device being reconnected to the electronic device, and determine that the file system is changed if the change time stamp of the file system is later than the disconnection time stamp.

4. The processor readable storage medium of claim 3, wherein the electronic device calculates the change time stamp and the disconnection time stamp from inputs selected from the group consisting of a root directory table last access time and a root directory table last modified time.

5. The processor readable storage medium of claim 1, wherein the processor readable program further causes the electronic device to calculate a disconnection hash for the storage device in response to the storage device being disconnected from the electronic device, calculate a connection hash in response to the storage device being reconnected to the electronic device, and determine that the file system is changed if the disconnection hash is not equivalent to the connection hash.

6. The processor readable storage medium of claim 5, wherein the processor readable program causes the electronic device to calculate the connection hash and the disconnection hash from inputs selected from the group consisting of a file system information sector free cluster count and a most recently allocated cluster identifier.

7. The processor readable storage medium of claim 1, wherein the connection is selected from the group consisting of a Universal Serial Bus (USB) connection, a wireless connection, and a network connection.

8. The processor readable storage medium of claim 1, wherein the electronic device re-indexes the file system by creating second metadata indexing the file system and the file system comprises image files, audio files, music files, and document files.

9. An apparatus comprising:
a memory device storing a processor readable program;
a processor executing the processor readable program, the processor readable program comprising
a detection module detecting a reconnection of a storage device to an electronic device wherein the storage device was previously connected to and then disconnected from the electronic device, the storage device comprising a file system and the electronic device storing first metadata indexing the file system;
a determination module determining if the file system is changed since the previous connection;
an access module accessing the file system using the first metadata in response to the file system not changing since the previous connection; and
a re-index module re-indexing the file system in response to the file system changing since the previous connection.

10. The apparatus of claim 9, wherein the determination module determines that the file system is changed from criteria selected from the group consisting of a master boot record modification and a set file system modification flag.

11. The apparatus of claim 9, wherein the detection module calculates a disconnection time stamp for the storage device in response to the storage device being disconnected from the electronic device and calculates a change time stamp in response to the storage device being reconnected to the electronic device, and the determination module determines that the file system is changed if the change time stamp of the file system is later than the disconnection time stamp.

12. The apparatus of claim 11, wherein the detection module calculates the change time stamp and the disconnection time stamp from inputs selected from the group consisting of a root directory table last access time and a root directory table last modified time.

13. The apparatus of claim 9, wherein the detection module calculates a disconnection hash for the storage device in response to the storage device being disconnected from the electronic device and calculates a connection hash in response to the storage device being reconnected to the electronic device, and the determination module determines that the file system is changed if the disconnection hash is not equivalent to the connection hash.

14. The apparatus of claim 13, wherein the detection module calculates the connection hash and the disconnection hash from inputs selected from the group consisting of a file system information sector free cluster count and a most recently allocated cluster identifier.

15. The apparatus of claim 9, wherein the connection is selected from the group consisting of a USB connection, a wireless connection, and a network connection.

16. A method comprising:
detecting, by use of a processor, a reconnection of a storage device to an electronic device wherein the storage device was previously connected to and then disconnected from the electronic device, the storage device comprising a file system and the electronic device storing first metadata indexing the file system;
determining if the file system is changed since the previous connection;
accessing the file system using the first metadata in response to the file system not changing since the previous connection; and
re-indexing the file system in response to the file system changing since the previous connection.

17. The method of claim 16, further comprising determining that the file system is changed from criteria selected from the group consisting of a master boot record modification and a set file system modification flag.

18. The method of claim 16, further comprising calculating a disconnection time stamp for the storage device in response to the storage device being disconnected from the electronic device, calculating a change time stamp in response to the storage device being reconnected to the electronic device, and determining that the file system is changed if the change time stamp of the file system is later than the disconnection time stamp.

19. The method of claim 18, further comprising calculating the change time stamp and the disconnection time stamp from inputs selected from the group consisting of a root directory table last access time and a root directory table last modified time.

20. The method of claim 16, further comprising calculating a disconnection hash for the storage device in response to the storage device being disconnected from the electronic device, calculating a connection hash in response to the storage device being reconnected to the electronic device, and determining that the file system is changed if the disconnection hash is not equivalent to the connection hash.
